(19) United States
(12) Patent Application Publication
(10) Pub. No.: US 2004/0089456 A1
(43) Pub. Date: May 13, 2004

(54) Fire-extinguishing agent and impregnant material

(76) Inventor: Franz Howorka, Vienna (AT)

Correspondence Address: WILLIAM COLLARD, COLLARD & ROE, P.C., 1077 NORTHERN BOULEVARD, ROSLYN, NY, 11576, US

(21) Appl. No.: 10/471,395

(22) PCT Filed: Mar. 13, 2002
(86) PCT No.: PCT/AT02/00083

(30) Foreign Application Priority Data
Mar. 13, 2001 (AT) A 393/2001

(51) Int. Cl. A62C 35/00

(52) U.S. Cl. 169/5

(57) ABSTRACT

A non-freezing fire extinguishing agent having the simultaneous effect of reducing the flammability of objects, which is made of an aqueous solution of alkali carbonate, citric acid, and ethylene glycol, is disclosed.

The present invention relates to an agent which not only displays a strong fire-extinguishing effect, but rather is also capable of reducing the flammability of objects. The active ingredients of the fire extinguishing agent according to the present invention coat objects of the source of the fire which are extinguished or not in flames with a protective coating at the same time, which suppresses the further expansion of the fire, but which may be removed easily after the fire is extinguished.

Fire extinguishing agents having a simultaneous preventive effect were disclosed in U.S. Pat. No. 1,278,716, in which solutions made of tertiary alkali metal citrate with alkali metal hydrogen carbonate were suggested. However, the addition of a suitable acid, such as sulfuric acid or hydrochloric acid, is also provided, so that the CO₂ necessary for spraying the agent arises. The sulfates or chlorides arising in this way form hard coatings on the sprayed objects after the evaporation of the water, which may typically only be removed with damage to the objects. The advantages of use of this agent are therefore significantly impaired.

European Patent Application EP 0 229 600 A1 discloses a fire extinguishing and impregnation agent, which is made of citric acid dissolved in water and quantities of sodium and potassium equimolar thereto. In addition, the pH value of the agent is set slightly alkaline. Under alkaline conditions, however, citric acid is comparatively poorly soluble, so that with the same potential fire load, either a lower impregnation effect must be accepted, or more agent must be used to achieve comparable impregnation effect, as will also be described. This problem is not addressed in European Patent Application EP 0 229 600 A1, however, instead, attention is placed on the pH value of the agent and measures are suggested for its stabilization.

German Patent DE 557 771 discloses a fire extinguishing agent which does not have any impregnation properties. Instead, it is based on the object of lowering the freezing point of a carbonate solution used for fire extinction purposes by using ethylene glycol. For this purpose, German Patent DE 557 771 suggests replacing the sulfuric acid used according to the related art with sulfonic acid, particularly chlorosulfonic acid.

Austrian Patent AT 369 995 and European Patent Application EP 059 178 A1 attempt to avoid these disadvantages in that a solution made of alkali metal citrate is suggested which is produced by mixing an alkali hydrogen carbonate with citric acid (2-hydroxy-1,2,3-propane tricarboxylic acid) in water. Upon spraying with the aid of a suitable propellant, the following reaction occurs at the source of the fire, similarly to the use of NaHCO₃ as an alkali hydrogen carbonate:

3 NaHCO₃+(cit)H₃43 Na₃(cit)+3 H₂O+3CO₂, Eq. 1:

in which (cit)H₃ stands for citric acid and Na₃(cit) stands for the resulting alkali metal citrate, in this case sodium citrate. The CO₂ is the decisive reaction product for extinguishing flame. In contrast, the sodium citrate is responsible for producing the coating which protects from the effect of fire. In a similar way, German Patent Application DE 35 25 684 A1 discloses a fire extinguishing and impregnation agent, which contains citrate, potassium hydroxide, and water or hydrogen carbonate and citric acid.

An extinguishing agent according to Austrian Patent AT 369 995, European Patent Application EP 059 178 A1, or German Patent Application DE 35 25 684 A1, which only has an alkali hydrogen carbonate and citric acid as its active ingredients, is, however, problematic in practical use. Thus, for example, it has been shown that for an effective coating using sodium citrate, comparatively large quantities of alkali hydrogen carbonate and citric acid are necessary. This also requires the use of a corresponding amount of water, which in turn elevates the probability of water damage. The goal of saving objects from the effect of flames via a protective coating is thus perverted by the probability of water damage. Furthermore, it has been shown that the formation of the protective coating is sufficient for small, strongly localized sources of fire, but rapidly reaches the limits of its effect in larger and widespread sources of fire.

It is therefore the object of the present invention to achieve, with the same extinguishing effect, improved protective effect through sodium citrate formation at higher concentrations of the starting materials in the extinguishing medium. It is therefore also the object of the present invention to reduce the amount of extinguishing agent required, with comparable extinguishing and impregnation effect, and thus ensure easier transport to the source of fire.

This object is achieved by the characterizing features of claim 1. Alkali carbonates, such as sodium carbonate, react with citric acid according to the following stoichiometry, in contrast to Equation 1:

3Na₂CO₃+2 (cit)H₃→2Na₃(cit)+3H₂O+3CO₂ Eq. 2:

It may thus be shown that if alkali carbonates are used, due to the reaction equilibrium it is possible in principle to form double the quantity of alkali metal citrates. Therefore, if the technical implementation of Equation 2 succeeds, it decisively increases the fireproofing effect.

A further advantage of sodium carbonate is shown first: it has better solubility in water than sodium hydrogen carbonate. The relative ratio of the solubility of sodium carbonate to sodium hydrogen carbonate varies depending on the temperature, but may sometimes be 1:2, at 60° C., for example. Better solubility in turn opens up the possibility of increasing the concentration or, if the absolute quantity remains the same, lower quantities of the solvent water.

However, the stoichiometry of Equation 2 also shows that the increased yield of sodium citrate may only be achieved when larger quantities of citric acid are brought into solution. Citric acid is very well soluble in water, but preferably under acidic conditions. The presence of the sodium carbonate, however, ensures an alkaline milieu. The advantages of the reaction according to Equation 2 become invalid, however, when it is not possible to bring approximately double the quantity of citric acid into solution as in Equation 1. It has now been shown that this may be ensured by the use of ethylene glycol (1,2-ethane diol), without significantly impairing the reaction kinetics. The saturation concentration of the citric acid may therefore be increased. For the extinguishing agent according to the present invention, the reaction partners sodium carbonate and citric acid are also to be admixed to saturation, so that elevation of the saturation concentration is decisive. Besides its properties as a solvent in water, ethylene glycol also displays the advantageous effect of lowering the freezing point. For a fire extinguishing agent which must also be reliably ready for use at low temperatures, this is a significant advantage.

Finally, the additional use of a volatile or gaseous propellant according to claim 2 eases the use of the fire extinction agent according to the present invention.

Therefore, a fire extinguishing agent is provided through the present invention which not only displays a significantly increased formation of protective coating to reduce the flammability of objects of the source of the fire in relation to known preparations, but is also distinguished by a lowered requirement for extinguishing water. This is results not only in the avoidance of water damage, but also eases transport to the source of fire due to the lower volume. The agent according to the present invention also provides the possibility of increasing the concentration of the active ingredients further by heating the solution, which finally leads to gelling of the agent. Therefore, larger quantities may be moved better during transport of the fire extinguishing agent. Dilution for use may be performed at the location of use.

The fire extinguishing and impregnation agent according to the present invention is capable of making paper, cellulose, textiles, wood, plastics, and much more fireproof. It is completely biologically degradable and is totally harmless to living creatures and the environment. The use of ethylene glycol also allows the extinction agent according to the present invention to be used without problems at temperatures far below zero and allows difficulties in the storage, transport, and use at low temperatures to be avoided.

1. A fire extinguishing agent having the simultaneous effect of reducing the flammability of objects, characterized in that it is made of an aqueous solution which contains an alkali carbonate, citric acid, and ethylene glycol.

2. The agent according to claim 1, characterized in that it also contains a volatile or gaseous propellant.

3. The agent according to claim 1 or 2, characterized in that the active ingredients are present in elevated concentrations due to heating of the aqueous solution.

4. The agent according to claim 3, characterized in that, due to heating of the aqueous solution, the agent is in gelled form during the transport to the source of fire.

5. The agent according to one of claims 1 through 4, characterized in that sodium carbonate and citric acid are admixed to saturation.
